(19) United States
(12) Patent Application Publication
(10) Pub. No.: US 2026/0119899 A1
(43) Pub. Date: Apr. 30, 2026

(54) GENERATIVE ADVERSARIAL IMITATION LEARNING(GAIL) DEVICE AND METHOD FOR GAIL AGENT TRAINING BASED ON EXPERT TRAJECTORY DATA

(71) Applicant: UIF (UNIVERSITY INDUSTRY FOUNDATION), YONSEI UNIVERSITY, Seoul (KR)

(72) Inventors: Sungbae CHO, Seoul (KR); Hyungjun MOON, Seoul (KR)

(73) Assignee: UIF (UNIVERSITY INDUSTRY FOUNDATION), YONSEI UNIVERSITY, Seoul (KR)

(21) Appl. No.: 18/934,141

(22) Filed: Oct. 31, 2024

(30) Foreign Application Priority Data
Oct. 29, 2024 (KR) 10-2024-0150148

(51) Int. Cl. G06N 3/092; G06N 3/045; G06N 3/094

(52) U.S. Cl. CPC G06N 3/092; G06N 3/045; G06N 3/094

(57) ABSTRACT

The present disclosure relates to a generative adversarial imitation learning device that trains an agent by imitating expert path data, which includes a learning initialization unit configured to receive path data of an expert composed of a sequence of actions performed in the past and initialize parameters of a global encoder shared by an agent and a discriminator, a sample extractor configured to extract samples from a path of the expert, a global encoder processor configured to train the agent and the discriminator through the samples to update the parameters of the global encoder and fix the parameters of the global encoder when the training is completed, and an agent learning unit configured to perform GAIL to imitate actions of the expert by the agent.

### CROSS-REFERENCE TO RELATED APPLICATION

This application claims under 35 U.S.C. § 119(a) the benefit of Korean Patent Application No. 10-2024-0150148 filed on Oct. 29, 2024, the entire contents of which is incorporated herein by reference.

### TECHNICAL FIELD

The present disclosure relates to generative adversarial imitation learning technology, and more specifically, to a generative adversarial imitation learning device and method for performing GAIL learning such that an agent imitates a behavior of an expert on the basis of expert path data.

### BACKGROUND

Autonomous agent learning is technology for training agents such that the agents make decisions on their own in a complex environment and is important technology utilized in various fields such as autonomous driving, robotics, and video games. In particular, imitation learning for training agents by imitating human behaviors complements the limitations of reinforcement learning and enables agents to perform complex tasks by utilizing expert demonstration data. Such imitation learning is also useful in environments in which it is difficult to define a clear reward signal.

Generative adversarial imitation learning (GAIL) based on a generative adversarial network (GAN) is a powerful technique for imitating behaviors of experts, and plays an important role in allowing an autonomous agent to learn an expert's path and solve complex tasks. However, the existing GAIL model have limitations in that it cannot sufficiently handle the complexity of input data and is not effective in suppressing incorrect behaviors of agents during the learning process. In particular, when dealing with high-dimensional inputs such as sequence data, performance degradation may occur, and there is a problem that it is difficult to accurately imitate behaviors of experts in complex environments.

To solve this problem, technology is required that allows agents to learn stably even in complex environments by applying more advanced imitation learning techniques and data processing methods.

Korean Patent Publication No. 10-2020-0115213 (2020.10.07) provides a system and method for temporarily switching a character or a virtual object controlled by a player in a video game to emulated control when the device of the player loses network connection or encounters a problem. This system allows the character to continue to operate until the end of a game session or until the problem is resolved by imitating the play style of the actual player, thereby providing an uninterrupted game experience to other players.

In a multiplayer game, multiple players can cooperate and play the game together. However, if one of the players cannot continue the game due to a network connection problem, excessive delay, or game application crash, the remaining players may experience a disadvantageous situation. This system addresses these issues by allowing a disconnected player's character to continue participating in the game in a similar manner to other players.

### PATENT LITERATURE

Korean Patent Publication No. 10-2020-0115213 (2020.10.07)

### DESCRIPTION

### Problem to be Solved

One embodiment of the present disclosure provides a generative adversarial learning device and method for performing GAIL learning such that an agent imitates a behavior of an expert on the basis of expert path data.

One embodiment of the present disclosure provides a generative adversarial learning device and method for initializing parameters of a global encoder shared by an agent and a discriminator, extracting samples from the expert path, training the agent and the discriminator to update the parameters of the global encoder, fixing the parameters when learning is completed, and performing GAIL learning such that the agent imitates a behavior of the expert on the basis of expert path data composed of past action sequences.

One embodiment of the present disclosure provides a generative adversarial learning device and method for receiving path data of an expert composed of past action sequences, initializing parameters of a global encoder shared by an agent and a discriminator, extracting samples from the path of the expert, training the agent and the discriminator to update the parameters of the global encoder, fixing the parameters when training is completed, and performing GAIL learning such that the agent imitates actions of the expert.

### Solution

In an embodiment, a generative adversarial imitation learning device includes a learning initialization unit configured to receive path data of an expert composed of a sequence of actions performed in the past and initialize parameters of a global encoder shared by an agent and a discriminator, a sample extractor configured to extract samples from a path of the expert, a global encoder processor configured to train the agent and the discriminator through the samples to update the parameters of the global encoder and fix the parameters of the global encoder when the training is completed, and an agent learning unit configured to perform GAIL to imitate actions of the expert by the agent.

The learning initialization unit may initialize an actor network that determines what action to take in a state of the agent and may initialize a critic network that evaluates whether an action selected by the agent is appropriate in the state. Additionally, the learning initialization unit may initialize a discriminator network that evaluates how similar an action of the agent is to an action of the expert.

The sample extractor may perform a function of repeatedly extracting states and actions on the path of the expert as the samples.

The global encoder processor may receive a state through an actor network for the agent, select one of actions selectable from the state, and performs the training by evaluating the selected action through the critic network and the discriminator network. Further, the global encoder processor may share global encoding units of the agent and the discriminator to convert the state into a feature vector and process the selected action. The global encoder processor may improve the training such that a cost function for evaluating imitation of the expert by the agent is minimized.

The agent learning unit may optimize a policy in the path of the expert through the GAIL to perform learning such that actions of the agent are similar to actions of the expert.

In an embodiment, a generative adversarial imitation learning method performed in a generative adversarial imitation learning device includes a learning initialization step of receiving path data of an expert composed of a sequence of actions performed in the past and initializing parameters of a global encoder shared by an agent and a discriminator, a sample extraction step of extracting samples from a path of the expert, a global encoder processing step of training the agent and the discriminator through the samples to update the parameters of the global encoder and fix the parameters of the global encoder when the training is completed, and an agent learning step of performing GAIL to imitate actions of the expert by the agent.

### Advantageous Effects

The disclosed technology has the following effects. However, it does not mean that a specific embodiment must include all or only the following effects, and therefore, the scope of the disclosed technology should not be understood as being limited thereby.

The generative adversarial imitation learning device according to one embodiment of the present disclosure is designed to perform GAIL learning such that an agent imitates a behavior of an expert on the basis of expert path data and learn a behavior similar to the expert based thereon, and thus it is possible to significantly improve the learning efficiency and accuracy of an autonomous agent.

The generative adversarial imitation learning device according to one embodiment of the present disclosure can initialize parameters of a global encoder shared by an agent and a discriminator, extract samples from the expert path, train the agent and the discriminator to update the parameters of the global encoder, fix the parameters when training is completed, and perform GAIL learning such that the agent imitates actions of the expert on the basis of expert path data composed of past action sequences, thereby allowing the agent to select an appropriate action even in a complex scenario and maintain a stable and consistent learning process.

The generative adversarial learning method according to one embodiment of the present disclosure can initialize parameters of a global encoder shared by an agent and a discriminator, extract samples from the expert path, train the agent and the discriminator to update the parameters of the global encoder, fix the parameters when training is completed, and perform GAIL learning such that the agent imitates actions of the expert on the basis of expert path data composed of past action sequences, thereby effectively reproducing expert-level behavior patterns and enabling the agent to select the most efficient and accurate action path even in complex tasks.

### BRIEF DESCRIPTION OF THE DRAWINGS

FIG. 1 is a diagram illustrating an input image sequence and output actions of an agent in a MineRL environment to describe a process in which the agent determines an action based on the input image sequence.

FIG. 2 is a diagram illustrating a configuration of a generative adversarial learning device according to an embodiment of the present disclosure.

FIG. 3 is a flowchart illustrating an operation of the generative adversarial learning device of FIG. 2.

FIG. 4A is a graph illustrating various configuration methods of reward functions used in agent learning.

FIG. 4B is a diagram illustrating a proposed GAIL-based learning algorithm.

FIG. 4C is a diagram illustrating a DI-GAIL algorithm with directed information.

FIG. 5 is a diagram illustrating examples of various experimental environments used for agent learning and performance evaluation.

FIG. 6 is a diagram comparing learning strategies of global encoders.

FIG. 7 is a diagram visualizing states encoded in a global encoder using the t-SNE technique.

FIG. 8 is a diagram visually illustrating trajectories and prediction results of each code in a navigation task using DI-Ours algorithm.

FIG. 9 is a diagram showing the usage ratio of unsupervised learned code variables in the DI-Ours algorithm.

### DETAILED DESCRIPTION

Specific structural or functional descriptions in the embodiments of the present disclosure introduced in this specification or application are only for description of the embodiments of the present disclosure. The descriptions should not be construed as being limited to the embodiments described in the specification or application. The present disclosure may, however, be embodied in many different forms, but should be construed as covering modifications, equivalents or alternatives falling within ideas and technical scopes of the present disclosure. Further, since effects disclosed herein do not mean that a specific embodiment should include all or only the effects, the scope of the present disclosure should not be construed as being limited thereto.

Meanwhile, the meaning of terms described herein will be understood as follows.

It will be understood that, although the terms “first”, “second”, etc. may be used herein to distinguish one element from another element, these elements should not be limited by these terms. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to” or “directly adjacent to” should be construed in the same way.

In the present disclosure, the singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In each step, reference characters (e.g. a, b, c, etc.) are used for the convenience of description. The reference characters do not designate the order of the steps, and the steps may be performed in a different order unless the context clearly indicates otherwise. That is, the steps may be performed in the specified order, may be performed substantially simultaneously, or may be performed in a reverse order.

The present disclosure can be implemented as a computer-readable code on a computer-readable recording medium. The computer-readable recording medium includes all types of recording devices in which data readable by a computer system is stored. Examples of the computer-readable recording medium include ROM, RAM, CD-ROM, magnetic tape, floppy disk, an optical data storage device, etc. In addition, the computer-readable recording medium may be distributed in a computer system connected via a network, so that computer-readable codes may be stored and executed in a distributed manner.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

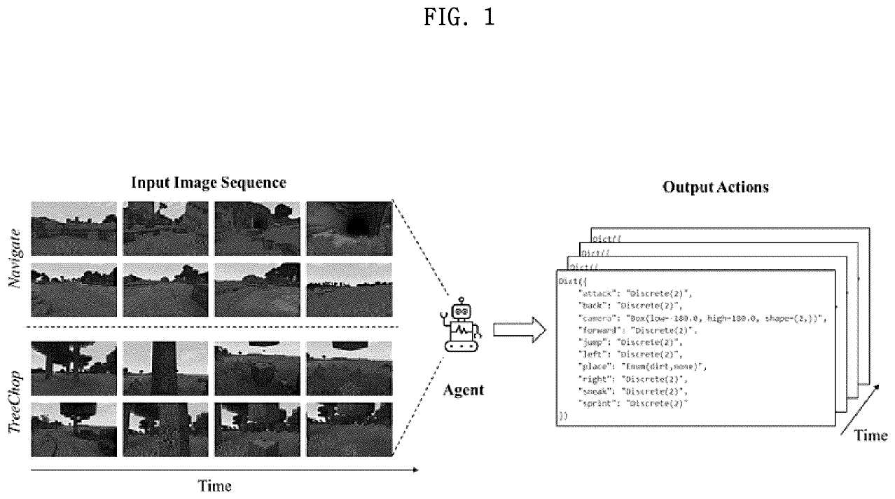

FIG. 1 is a diagram illustrating an input image sequence and output actions of an agent in a MineRL environment to describe a process in which the agent determines an action based on the input image sequence.

The input image sequences for the Navigate and TreeChop tasks are arranged in time order on the left side of FIG. 1, and the agent collects such visual information to analyze the environment. The agent that processes the input image sequence is shown at the center of FIG. 1, and the agent encodes sequence data using a global encoder and extracts meaningful information through the encoding. Output actions selected on the basis of results of the agent analyzing the input image sequence are listed on the right side of FIG. 1, and these actions are actions for performing various tasks such as “attack”, “move”, “jump”, and “sprint” and are specifically displayed in time order.

In addition, FIG. 1 visually illustrates a process in which the agent processes the input image sequence through extended GAIL and selects an appropriate action for each situation. The global encoder efficiently encodes the input image sequence to allow the agent to effectively analyze visual information of the environment, and accordingly, the agent can select and perform optimal actions even in a complex scenario such as Navigate and TreeChop tasks.

Finally, by imitating and learning human demonstration data, the agent acquires the ability to respond appropriately in various situations, and based on this, the agent can efficiently perform complex tasks in the Minecraft environment.

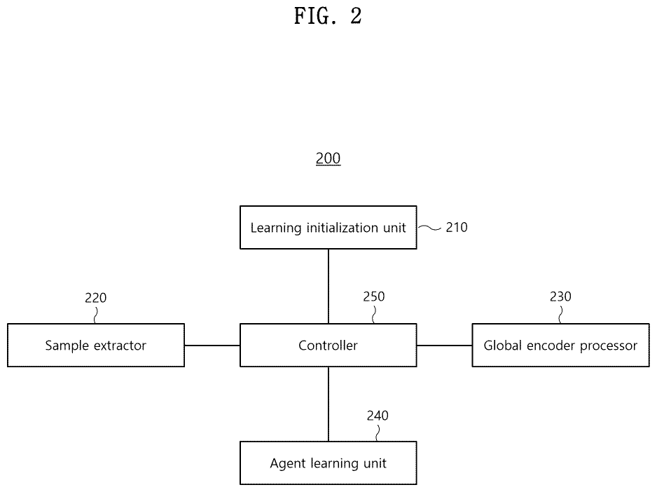

FIG. 2 is a diagram illustrating a configuration of a generative adversarial learning device according to one embodiment of the present disclosure.

Referring to FIG. 2, the generative adversarial learning device 200 may include a learning initialization unit 210, a sample extractor 220, a global encoder processor 230, an agent learning unit 240, and a controller 250.

The learning initialization unit 210 may receive path data of an expert composed of a sequence of actions performed in the past and initialize parameters of a global encoder shared by an agent and a discriminator. The learning initialization unit 210 may perform a function of initializing an actor network for determining an action of the agent, a critic network for evaluating the value of a selected action, and a discriminator network for evaluating how similar an agent's action is to an action of an expert.

More specifically, the learning initialization unit 210 may initialize the parameters of the global encoder shared by the agent and the discriminator, and this initialization process provides a basic structure for the agent and the discriminator to start learning and allows input data and states to be processed consistently in the future learning process. In conclusion, effective initialization of the parameters of the global encoder has a significant impact on the efficiency and stability of learning, and accordingly, the agent can interpret complex states in various environments and learn appropriate actions.

The sample extractor 220 may extract samples from an expert path composed of a sequence of actions performed in the past. The sample extractor 220 may analyze expert path data and repeatedly extract states and actions included in the path as samples to provide data necessary for the learning process of the agent.

The global encoder processor 230 may train the agent and the discriminator to update the parameters of the global encoder, and when training is completed, fix the parameters.

The global encoder processor 230 may receive a state input through the actor network of the agent and select one of various actions that can be selected in the state. In this process, the selected action is evaluated through the critic network and the discriminator network, and learning of the agent may be performed based on this evaluation. Here, the critic network can evaluate the appropriateness of the action selected by the agent in a given state and determine how much the action contributes to goal achievement. The discriminator network can support learning such that the agent can imitate an expert behavior pattern on the basis of the expert path data by comparing an agent's behavior with an expert's behavior.

The global encoder processor 230 shares the global encoder through a global encoding unit of the agent and a global encoding unit of the discriminator, and each unit may perform learning such that an agent's behavior can be processed by converting a state into a feature vector.

In addition, the global encoder processor 230 can improve learning to minimize a cost function in order to evaluate the agent's expert imitation, and thus the agent can effectively imitate the expert path data.

The agent learning unit 240 may optimize the policy in the expert path through GAIL to perform learning such that an action of the agent is similar to an action of the expert. In this process, the agent can imitate the expert's behavior pattern and learn the optimal policy to support consistent performance in various environments.

The controller 250 may manage the overall control operation of the generative adversarial imitation learning device 200, and manage a control flow or a data flow between the learning initialization unit 210, the sample extractor 220, the global encoder processor 230, and the agent learning unit 240.

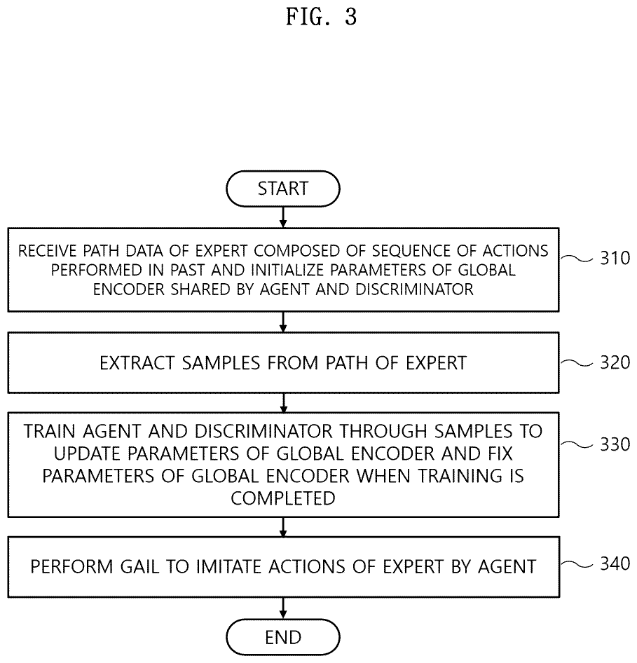

FIG. 3 is a flowchart illustrating the operation of the generative adversarial learning device of FIG. 2.

Referring to FIG. 3, a generative adversarial learning method 300 performed in the generative adversarial learning device 200 may be performed through a learning initialization step 310 of receiving expert path data composed of a sequence of actions performed in the past and initializing parameters of a global encoder shared by an agent and a discriminator, a sample extraction step 320 of extracting samples from the expert path, a global encoder processing step 330 of training the agent and the discriminator through the extracted samples to update the parameters of the global encoder, and when training is completed, fixing the parameters of the global encoder, and an agent learning step 340 of performing GAIL such that the agent imitates actions of the expert.

In the learning initialization step 310, the parameters of the global encoder shared by the agent and the discriminator may be initialized by receiving expert path data composed of a sequence of actions performed in the past. The learning initialization step 310 provides the basis for initial learning, and can support learning of consistent state representation by setting the parameters of the global encoder, and the initialized parameters can play an important role in processing input data and selecting actions in the subsequent learning process.

In the sample extraction step 320, input data for training the agent and the discriminator can be generated by repeatedly sampling states and actions from the expert path data. The sample extraction step 320 provides multiple state-action pairs such that the agent can learn in various situations, and can secure learning materials for imitating expert's behavior patterns.

In the global encoder processing step 330, the agent and the discriminator may be trained using the extracted sample data, and the parameters of the global encoder may be updated through this. When training is completed, the parameters of the global encoder are fixed, it is ensured that consistent state representation is maintained in the subsequent learning process, the learning stability of the agent is improved, and the learning efficiency is maximized.

In the agent learning step 340, learning may be performed such that the agent imitates expert's actions through GAIL. The agent optimizes actions thereof on the basis of feedback from the trained global encoder and discriminator and can learn actions that are closer to the expert policy.

The generative adversarial learning device 200 according to one embodiment of the present disclosure is a system designed to enable an agent to learn an optimal policy by imitating an expert behavior. This device 200 initializes the parameters of the global encoder on the basis of an action sequence of an expert, and thereby supports the agent and the discriminator to learn consistent state representation.

### 1. Necessity of Imitation Learning (IL) and Inverse Reinforcement Learning (IRL)

Imitation learning enables an agent to learn an expert behavior in an environment without reinforcement signals, which can be very useful for training the agent in a complex environment without direct rewards. IRL is an approach that learns the best policy by inferring the optimal reward structure based on expert actions, and this can be the basis of GAIL.

The following mathematical expression 1 shows a general objective function of IRL for a given state and action a.

$$\begin{matrix}[ Mathematical expression 1 ] & \\ {max}_{c ∈ C} ( {min}_{π ∈ Π} - H ( π ) + {𝔼}_{π} [ c ( s , a ) ] - {𝔼}_{{π}_{E}} [ c ( s , a ) ] ) & ( 1 )\end{matrix}$$

Here, H(π)≡E_{π}[−log π(a|s)] denotes the γ-discounted entropy of policy π, and π_{E} denotes the expert policy that is given as sampled trajectories in practice.

Mathematical expression 1 shows the purpose of learning the optimal reward scheme based on the entropy of the policy and expert trajectories.

### 2. Generative Adversarial Imitation Learning (GAIL)

Generative adversarial imitation learning (GAIL) is a method that extends the concept of IRL to the generative adversarial network (GAN) structure, designed to allow an agent to learn optimal actions by imitating expert actions. Here, the agent and the discriminator interact, and the discriminator can provide feedback by determining how similar agent actions are to expert actions.

The formal GAIL objective function can be represented as the following mathematical expression 2.

$$\begin{matrix}[ Mathematical expression 2 ] & \\ {min}_{π} {max}_{{D}_{s \sim S , a \sim A} ∈ ( 0 , 1 )} ( {𝔼}_{π} [ log D ( s , a ) ] + {𝔼}_{{π}_{E}} [ log ( 1 - D ( s , a ) ) ] ) & ( 2 )\end{matrix}$$

Here, D is the discriminator that can distinguish between state-action pairs generated by π or π_{E}. Theoretically, it has been proven that the optimization process of mathematical expression (2) includes both IRL and RL phases.

Mathematical expression 2 can enable learning through interaction between the agent and the discriminator in the GAN structure. Here, the discriminator can determine how similar agent actions are to expert actions.

### 3. Importance of GAIL Extension and Reward Function

The existing GAIL has limitations in processing complex environments and high-dimensional data. Modified techniques such as VAIL and DI-GAIL have been proposed to improve the performance of GAIL, and can maximize the learning effect through a better reward structure. The reward function provides important feedback for the agent to learn correct behaviors, and can suppress incorrect behaviors and reinforce correct behaviors.

The following mathematical expression 3 represents the objective function for stably training the global encoder in a pre-training phase.

$$\begin{matrix}[ Mathematical expression 3 ] & \\ {min}_{π} {max}_{{D}_{s \sim S , a \sim A} ∈ ( 0 , 1 )} ( {𝔼}_{π} [ log D ( {E}_{BC} ( s ) , a ) ] + {𝔼}_{π E} [ log ( 1 - D ( {E}_{BC} ( s ) , a ) ) ] & ( 3 )\end{matrix}$$

In this phase, a behavior cloning (BC) algorithm may be used to transfer and fix the encoder trained from the expert trajectories to the global encoder, and the pre-trained global encoder can maintain consistent state representation between the agent and the discriminator in the subsequent GAIL-style learning process.

The above mathematical expression 3 can serve to establish the initial foundation of GAIL and ensure the stability of learning.

In order to overcome the limitations of the existing reward function, the RL agent interprets min_{π}E_{π}[log D(s,a)] in the above mathematical expression 2 as a reward function, where D(s,a) is limited to the range of [0,1]. However, if the researcher defines R(s,a)=−log D(s,a), the agent will receive a positive reward regardless of whether it has learned, which may cause a problem that makes it difficult to improve incorrect behaviors. To solve this problem, a new reward function including an entropy regularization term needs to be introduced, and this new function can have the effect of suppressing incorrect behaviors and reinforcing correct behaviors by allowing negative ranges of rewards. This transformation can enable the agent to learn stably even near the equilibrium state.

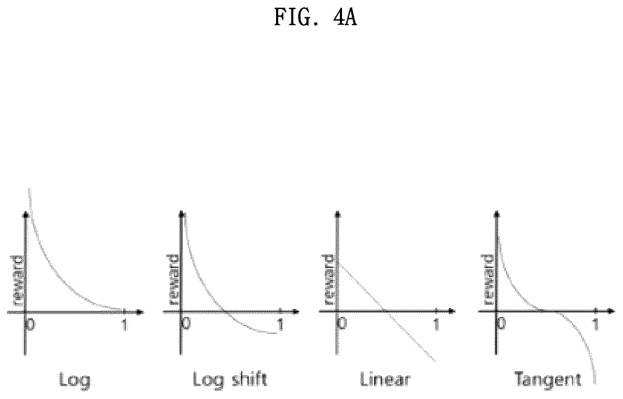

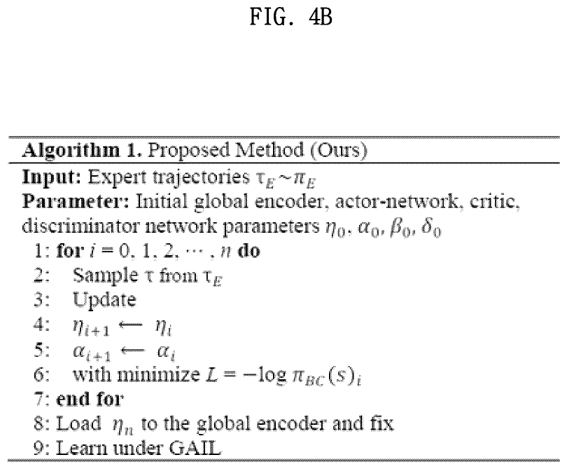

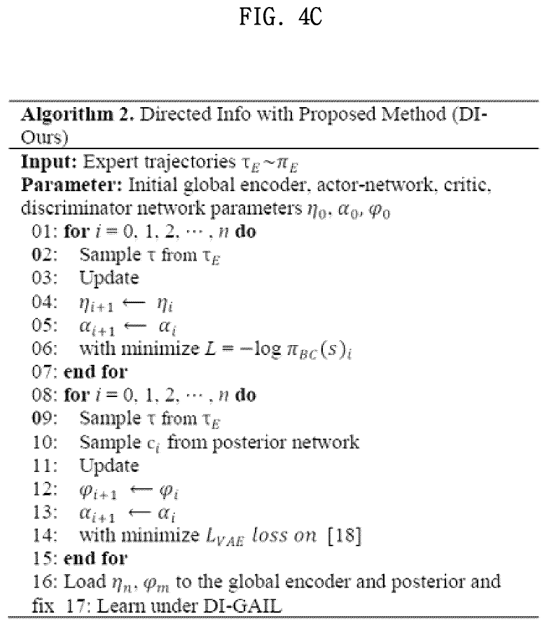

FIG. 4A is a graph illustrating various configuration methods of reward functions used in agent learning.

Referring to FIG. 4A, among the reward functions used in agent learning, the log reward function, the log shift reward function, the linear reward function, and the tangent reward function are illustrated.

The log reward function is used in basic GAIL, and a reward can be defined as in the following mathematical expression 4.

$$\begin{matrix}[ Mathematical expression 4 ] & \\ R ( s , a ) = - log D ( s , a ) & ( 4 )\end{matrix}$$

The log function of the above mathematical expression 4 can gradually decrease the reward as the agent behavior differs from the expert behavior. However, this method can provide positive rewards at all phases, and thus it may not sufficiently suppress undesirable behaviors.

The log shift reward function is an adjusted form of the existing log function, and can be represented as in the following mathematical expression 5.

$$\begin{matrix}[ Mathematical expression 5 ] & \\ R ( s , a ) = - log ( D ( s , a ) + 0.5 ) & ( 5 )\end{matrix}$$

The reward method of the above mathematical expression 5 can change reward calculation to impose a stricter penalty on undesirable behaviors. This allows the agent to better follow the expert trajectory, increasing the reward faster when matching with the expert behavior is high and decreasing the reward slowly when the matching is low.

The linear reward function can be expressed as a simple linear function that directly adjusts the reward based on the similarity between the agent behavior and the expert behavior. The linear reward can make a reward gradient of learning clear by giving a positive value when the agent behavior matches the expert behavior and giving a negative value when the agent behavior does not match.

The tangent reward function works on a similar principle to the linear reward, but it can apply a steeper penalty. It is effective in preventing the agent from deviating significantly from the expert behavior, and can provide a larger penalty for undesirable behavior. In particular, it can be usefully used in tasks in which the consistency with expert trajectories is important.

This reward system plays an important role in balancing exploration (trying new behaviors) and exploitation (repeating successful behaviors), and by selecting an appropriate reward system according to characteristics of a task, the agent learning performance can be optimized in various environments.

FIG. 4B is a diagram illustrating a proposed GAIL-based learning algorithm.

Referring to FIG. 4B, the learning procedure of the extended GAIL method is described, and the algorithm is designed such that the agent learns based on expert action trajectories. This algorithm uses expert trajectory data as input and can set parameters of an initial global encoder, an actor network, a critic network, and a discriminator network. Learning is iteratively performed, the expert path is sampled at each step, and the parameters are updated to optimize the action replication policy. In this process, the cost function can be minimized to support the agent to imitate expert behaviors. After learning is complete, the parameters of the trained global encoder are fixed to provide consistent state encoding, and then the agent learns a more sophisticated policy through GAIL.

FIG. 4C is a diagram illustrating the DI-GAIL algorithm with directed information.

Referring to FIG. 4C, Algorithm 2. Directed Info with Proposed Method (DI-Ours) is designed to combine the Directed Information technique with the proposed extended GAIL method to enable the agent to learn. This algorithm uses expert path data as input, and can set the parameters of the initial global encoder, actor network, critic network, and discriminator network.

In Algorithm 2, in the first iterative learning step, the system can sample the expert path to perform initial learning. In each step, the parameters are updated while minimizing the cost function L=−log π_{BC}(s)ᵢ to optimize the action replication policy of the agent.

In Algorithm 2, in the second iterative learning step, after sampling from the expert path, the latent variable cᵢ can be sampled in a posterior network. By updating φᵢ and αᵢ, learning is performed in the direction of minimizing L_{V AE}loss. This allows the agent to learn more sophisticated behavior patterns.

Finally, after learning is completed, the system fixes the parameters of the trained global encoder and the parameters of the posterior network. Thereafter, DI-GAIL learning is performed to support the agent to learn more sophisticated policies. This algorithm utilizes the Directed Information technique to enable the agent to learn complex behavior patterns more effectively and apply the same in various environments.

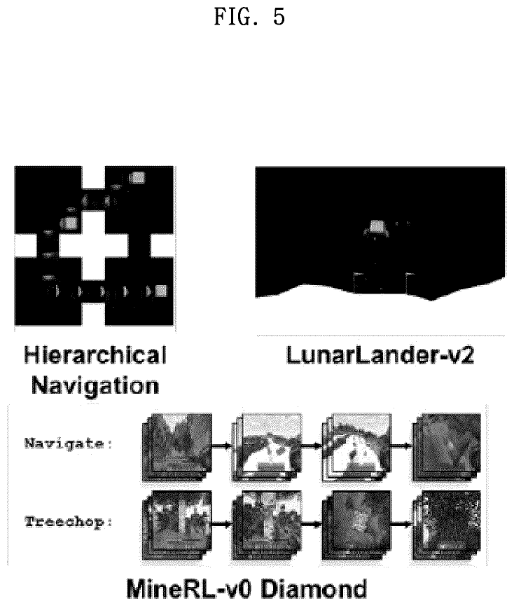

FIG. 5 is a diagram illustrating examples of various experimental environments used for agent learning and performance evaluation.

Referring to FIG. 5, verification of the performance of the extended GAIL method was performed in three environments: Hierarchical Navigation, LunarLander-v2, and MineRL-v0 Diamond. In each environment, the learning performance of the agent and the effect of reward penalty were analyzed, and the general applicability of the proposed method was evaluated through the same.
1. Hierarchical Navigation: The image on the upper left is a 7×7 grid environment with four rooms connected via a bottleneck passage. In this environment, the agent must move through each room to find a specific goal, which is a key and a car. The state input is provided as a 32×32×4 RGB image.
2. LunarLander-v2: The image on the upper right represents the LunarLander-v2 environment of OpenAI Gym. In this environment, the agent performs the task of firing the engine and landing safely on the landing pad. The state consists of position, speed, angle, and contact state of the legs, and the reward varies depending on each action of the agent.
3. MineRL-v0 Diamond: The image below is a visual representation of an experiment based on the Minecraft environment. This environment consists of two tasks: Navigation and TreeChop. In the Navigation task, the ability of the agent to move to the target point in various terrains is evaluated. In the TreeChop task, the process of harvesting trees is reproduced, and the agent receives a reward for each tree harvested.

The hierarchical navigation environment is designed such that the agent finds the target point by moving through rooms connected via a bottleneck passage, and thus the hierarchical problem-solving ability of the proposed method can be verified. In the LunarLander-v2 environment, the effect of reward penalty and the adaptation ability of the agent can be analyzed through the process in which the agent fires the engine and lands safely. In the MineRL-v0 Diamond environment, the ability of the agent to move or harvest resources in complex terrains is evaluated through the Navigation and TreeChop tasks, and the performance can be compared with existing reinforcement learning models.

Extended GAIL is a learning method designed to improve the existing GAIL technique such that the agent can effectively imitate a behavior of an expert. This extended GAIL method can overcome the limitations of the existing GAIL by enhancing the ability to handle complex input data and hierarchical structures.

### 1. Theoretical Structure of Extended GAIL

The core elements of the extended GAIL are the global encoder and reward penalty.

The global encoder can efficiently encode visual information of a state such that the agent and the discriminator can understand the same input state, thereby providing a consistent state representation. This can extract meaningful information from complex image sequence input and increase the stability of the learning process.

The reward penalty is a concept introduced to induce the agent to reduce incorrect behaviors and to learn correct behaviors, and can optimize the learning performance of the agent by designing various forms of reward functions including negative rewards in addition to the existing positive rewards.

Extended GAIL may be combined with existing variants such as VAIL and DI-GAIL, and can improve learning performance in various environments by introducing the global encoder and the reward penalty and exhibit better performance as compared to existing reinforcement learning models.

### 2. Experimental Approach to Extended GAIL (Extended-GAIL, E-GAIL)

Apart from the theoretical approach to the proposed E-GAIL, practical improvement of the performance of E-GAIL was attempted through experiments.

In the experiments, the results of applying the global encoder and the reward penalty individually to verify the flexibility and performance improvement of the proposed E-GAIL were evaluated. Specifically, the performance improvement was confirmed by combining the proposed reward penalty with existing GAIL variants such as VAIL and DI-GAIL, proving that GAIL performance can be effectively improved in various environments. In addition, the effectiveness of the reward penalty was experimentally verified by independently applying the reward penalty to GAIL without the global encoder. Such experimental results demonstrate that E-GAIL can achieve superior performance not only by combining the global encoder and the reward penalty, but also by applying these factors independently. In particular, the learning efficiency was further improved by using the PPO algorithm instead of the conventional TRPO for agent learning.

The results in Table 1 below compare the performance in hierarchical navigation tasks.

TABLE 1
^{a} RESULTS ON THE HIERARCHIAL NAVIGATION TASK

| Model | Best score | Average score | Meets-10 |
|---|---|---|---|
| GAIL | −95.184 | −97.15 ± 0.90 | — |
| VAIL | −98.964 | −99.54 ± 0.21 | — |
| GAIL_LS | −1.334 | −30.81 ± 30.11 | 28K |
| VAIL_LS | −1.163 | −26.82 ± 29.08 | 23K |
| GAIL_GE | −98.874 | −99.15 ± 0.04 | — |
| Ours | 1 | −5.81 ± 14.18 | 12K |
| Ours + VDB | 0.996 | −3.27 ± 10.35 | 3K |
| DI-GAIL_GE | −93.055 | −96.91 ± 2.05 | — |
| DI-Ours | 1 | −6.13 ± 14.81 | 12K |
| DI-Ours + VDB | 0.996 | −4.57 ± 15.72 | 3K |

According to the results in Table 1 above, the existing GAIL and VAIL techniques failed to solve the task. However, the agent to which only the global encoder or the reward penalty was applied showed some performance improvement, but still did not solve the complete problem. On the other hand, the agent to which E-GAIL was applied reached the highest score and showed stable performance. In addition, Ours+VDB and DI-Ours+VDB showed excellent performance, which is an important experimental result that emphasizes the scalability of E-GAIL and applicability thereof in various environments.

To evaluate the performance in the hierarchical environment, the performance of E-GAIL was evaluated in two main experimental environments.

Firstly, in a hierarchical navigation task, various GAIL variations were applied for 1000 episodes, and the performance and learning stability were measured based on the average return. The experimental results showed that the existing GAIL and VAIL failed to solve the task. On the other hand, the agent to which only the global encoder or the reward penalty was applied showed some performance improvement, but still did not solve the complete problem. However, the agent to which E-GAIL was applied showed stable learning performance, reaching the highest score. In addition, E-GAIL exhibited effective performance when applied to GAIL without the global encoder.

Secondly, comparative experiments with various existing reinforcement learning models were performed in the MineRL-v0 environment. In particular, E-GAIL showed human-like performance in the TreeChop task and outperformed existing methods. According to the results in Table 2 below, E-GAIL outperformed PreDQN, which showed the highest performance among existing models, by more than three times in the Navigation task. This proved that E-GAIL can achieve high learning performance and reward optimization in various environments.

TABLE 2
^{b} RESULTS ON THE MINECRAFT TASKS.

Tasks with average score

| Model | Tree chop | Navigation |
|---|---|---|
| Random** | 3.81 ± 0.57 | 1.00 ± 0.95 |
| DQN** | 3.75 ± 0.61 | 0.00 ± 0.00 |
| A2C** | 2.61 ± 0.50 | 0.00 ± 0.00 |
| BC** | 43.9 ± 31.46 | 4.23 ± 4.15 |
| PreDQN** | 4.16 ± 0.82 | 6.00 ± 4.65 |
| GAIL | 11.78 ± 4.42 | 3.48 ± 2.43 |
| DI-GAIL | 15.89 ± 8.15 | 7.25 ± 5.21 |
| AM-GAIL | 42.94 ± 12.70 | 6.09 ± 1.84 |
| DI-Ours | 61.99 ± 0.79 | 19.23 ± 6.72 |
| DI-Ours + VDB | 63.17 ± 0.88 | 19.54 ± 4.36 |
| HUMAN** | 64.00 ± 0.00 | 100.00 ± 0.00 |

**This score was reported at [6]

Table 3 below shows the results of comparing reward penalty schemes, evaluating the performance of various reward penalty techniques in Navigation and LunarLander-v2 tasks.

TABLE 3
COMPARISON OF REWARD PENALIZATION SCHEMES
ON NAVIGATION AND LUNALANDER TASKS

Average score

| Scheme | Navigation | LunadLander-v2 |
|---|---|---|
| Log | −99.91 ± 0.09 | 1.00 ± 0.95 |
| Log scaled | −96.87 ± 3.02 | 0.00 ± 0.00 |
| Log shift | −6.35 ± 14.66 | 0.00 ± 0.00 |
| Linear | −5.00 ± 11.79 | 4.23 ± 4.15 |
| Tan | 4.16 ± 0.82 | 6.00 ± 4.65 |

In the above Table 3, reward schemes such as Log, Log shift, Linear, and Tan are presented, and the Tan scheme is more stable and recorded a higher average score than other methods. Accordingly, it can be confirmed that the performance of E-GAIL is greatly dependent on the reward penalty design and that effective reward design is essential for improving the learning performance of the agent.

In conclusion, these experimental results demonstrate the scalability of E-GAIL and superior performance thereof in various application environments, and emphasize that the combination of the global encoder and the reward penalty has a positive effect on the agent learning performance.

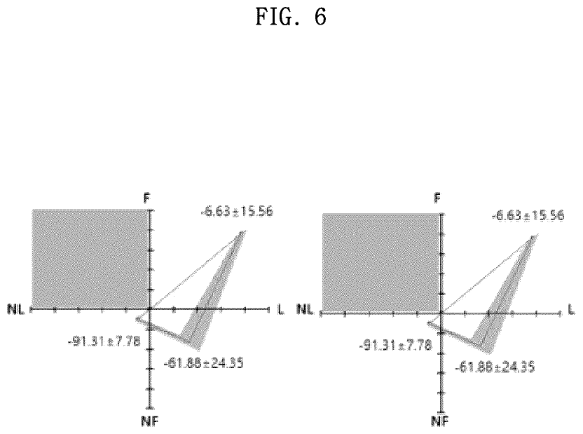

FIG. 6 is a diagram comparing learning strategies of the global encoder.

Referring to FIG. 6, the left side of the figure shows Ours strategy, and the right side of the figure shows Ours+VDB strategy.

This experiment emphasizes that effectively managing the weights of the global encoder is important for improving the stability and performance of learning. Specifically, two key strategies are used: the first is to load the weights of the global encoder during the behavior cloning (BC) pre-training phase (notation: Q), and the second is to fix the weights of the global encoder during the training process (notation: L).

In the experiment, two strategies, “Ours” and “Ours+VDB”, were compared, and the method of randomly initializing and not fixing the weights was excluded from the results due to poor performance.

It can be ascertained from FIG. 6 that loading and fixing the weights of the global encoder is important for reducing the instability during training and effectively training the agent.

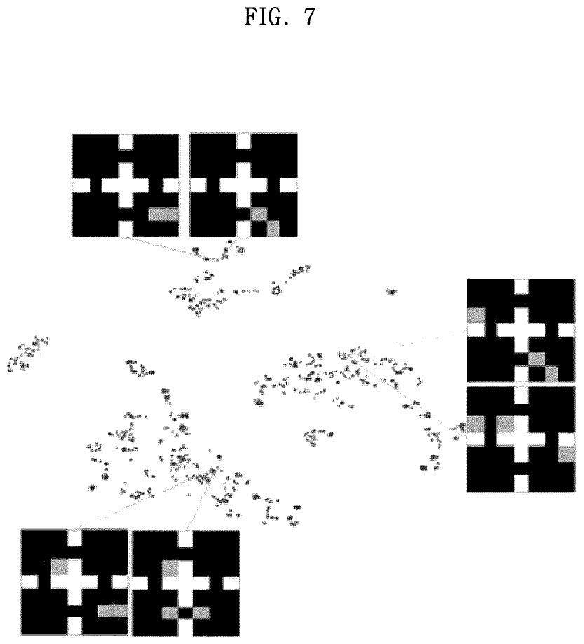

FIG. 7 is a diagram visualizing states encoded in the global encoder using the t-SNE technique.

Referring to FIG. 7, the encoder analyzes states by encoding important information according to the current situation of the agent, and visualizes the same to identify which elements the agent pays attention to during learning. For example, when the agent has not yet acquired a key, the encoder can preferentially recognize the location of the key and induce the agent to learn this. On the other hand, after the agent has acquired the key, the state can be encoded such that the agent focuses more on information on the distance to a target car. In this way, the encoder can extract necessary information according to the situation and support the agent to select the optimal action during learning based on the information.

Referring to the lower left part of FIG. 7, it can be confirmed that the encoder mainly focuses on the location of the key when the agent has not yet acquired the key. At this time, the encoded states are visualized to reflect the location of the key more than the location of the car. On the other hand, the upper right part shows the state after the agent has already acquired the key, and in this case, the encoder pays attention to the distance between the agent and the car and encodes the same as an important element.

Such an operation of the global encoder helps the agent clearly recognize what it should learn first in the current state. This allows the agent to focus on important elements during the learning process and improves the efficiency of learning.

Analysis of reward penalty is an important concept introduced to optimize the learning performance of the agent. In one embodiment of the present disclosure, five reward systems were tested in the LunarLander-v2 environment and effects thereof were compared. The reward systems used were the original log reward, scaled log reward, shifted log reward, linear reward, and tangent reward, and the linear and tangent rewards were set to have positive and negative values in specific sections.

According to the results in Table 3, the agent to which the reward penalty was applied exhibited significantly higher performance than the case in which the reward penalty was not applied, and in particular, the linear system recorded the best performance in the LunarLander-v2 environment. This suggests that selecting an appropriate reward system can significantly improve the learning performance of the agent.

In conclusion, the reward penalty serves as an important hyperparameter that can more effectively induce the agent behavior and maximize the efficiency and performance of learning.

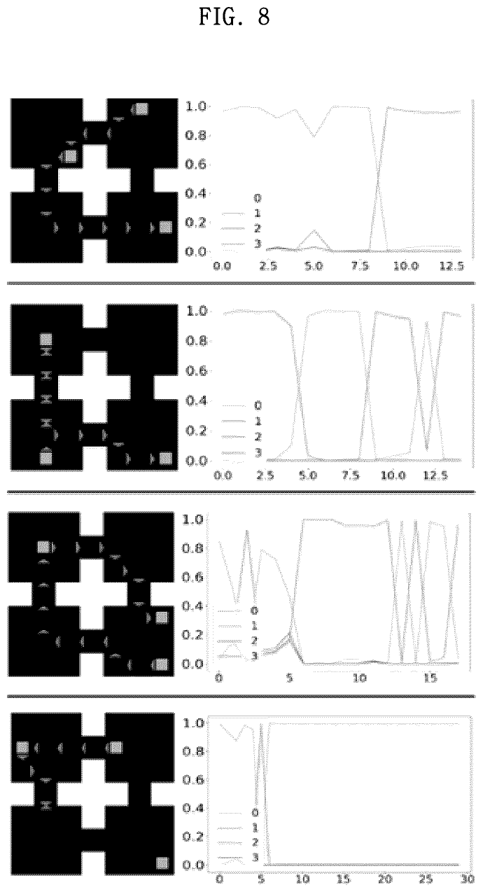

FIG. 8 is a diagram visually illustrating trajectories and prediction results of each code in a navigation task using DI-Ours algorithm.

Referring to FIG. 8, the left side of FIG. 8 shows the path through which the agent moved, the arrow indicates the direction of movement and the color indicates the latent code used. The right graph of FIG. 8 shows the probability distribution of codes used by the agent at each timestep.

An important point that can be confirmed through FIG. 8 is that the agent uses two latent codes to follow a specific movement pattern. For example, the pink code (0) is mainly used to move the agent to the left and downward, and the yellow code (1) is used to move the agent to the right and upward. This allows the agent to effectively learn various movement strategies.

The last row of FIG. 8 shows a case where the agent failed to learn when there was no pre-learned code distribution. At the eighth timestep, the code instructs the agent to move downward, but the agent makes an error of moving upward in a wrong direction. This result suggests that the pre-learned code distribution plays an important role in properly guiding the agent behavior and supporting more effective learning.

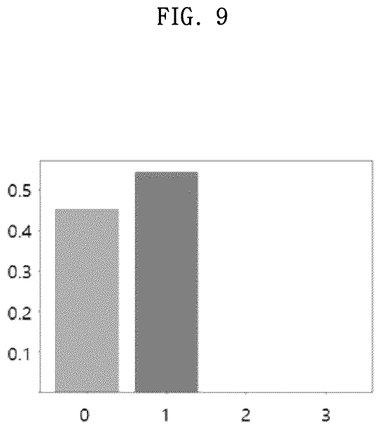

FIG. 9 is a diagram showing the usage ratio of unsupervised learned code variables in the DI-Ours algorithm.

Referring to FIG. 9, it can be confirmed that among the latent codes set as four categorical variables, the agent mainly uses only two codes (codes 0 and 1).

As a result of analysis of FIG. 9, code 0 in pink was used at a rate of about 40% in all episodes, which is the code mainly utilized when the agent moved to the left and downward. Code 1 in yellow was used at a rate of more than 50%, and was used when the agent moved to the right and upward.

In FIG. 9, it can be confirmed that the remaining two codes (2 and 3) were not used. This suggests that the agent optimized its strategy around the two main codes for specific directional movements through learning. These results show that the latent codes learned unsupervised through DI-GAIL play an important role in effectively guiding the agent behavior.

DI-Ours agent can effectively solve hierarchical problems by learning consistent and meaningful latent code variables in an unsupervised manner. The pre-trained encoder plays an important role in improving the agent performance and can contribute to alleviating the inherent instability of the GAIL method. However, the pre-learning method of reconstructing the World Model did not show a significant effect in the experiment. Therefore, further research will be needed to find a better structure or pre-learning technique that can improve the performance of the global encoder. In particular, transfer learning for the global encoder can be a promising approach in the future.

In addition, the reward penalty is an important factor in improving performance in imitation learning tasks, and the proposed method is evaluated as a contribution that is relatively easy to implement and highly applicable to various application environments. In real problems that deal with complex hierarchical structures and high-dimensional state spaces, such as raw image sequences, the proposed method has high potential for learning hierarchical policies from raw input images.

Although the above has been described with reference to preferred embodiments of the present disclosure, those skilled in the art will understand that the present disclosure can be modified and changed in various manners within the scope and spirit of the present disclosure as set forth in the claims below.

### Acknowledgement

Project Serial No: 2710006677
Project No: RS-2020-II201361
Department: Ministry of Science and ICT
Project management (Professional) Institute: Institute of Information & Communications Technology Planning & Evaluation
Research Project Name: Nurturing ICT and Broadcasting Innovation Talents (R&D)
Research task Name: Artificial Intelligence Graduate School Support Project (Yonsei University)
Project Performing Institute: University Industry Foundation, Yonsei University
Research Period: 2024 Jan. 1˜2024 Dec. 31

### Detailed Description of Main Elements

200: Generative adversarial imitation learning device
210: Learning initialization unit
220: Sample extractor
230: Global encoder processor
240: Agent learning unit
250: Controller

What is claimed is:

1. A generative adversarial imitation learning device comprising:
a learning initialization unit configured to receive path data of an expert composed of a sequence of actions performed in the past and initialize parameters of a global encoder shared by an agent and a discriminator;
a sample extractor configured to extract samples from a path of the expert;
a global encoder processor configured to train the agent and the discriminator through the samples to update the parameters of the global encoder and fix the parameters of the global encoder when the training is completed; and
an agent learning unit configured to perform GAIL to imitate actions of the expert by the agent.

2. The generative adversarial imitation learning device of claim 1, wherein the learning initialization unit initializes an actor network that determines what action to take in a given state for the agent.

3. The generative adversarial imitation learning device of claim 2, wherein the learning initialization unit initializes a critic network that evaluates a value of an action selected in a specific state for the agent.

4. The generative adversarial imitation learning device of claim 1, wherein the sample extractor repeats a process of extracting states and actions on the path of the expert as the samples.

5. The generative adversarial imitation learning device of claim 1, wherein the global encoder processor receives a state through an actor network for the agent, selects one of actions selectable from the state (hereinafter, selected action), and performs the training by evaluating the selected action through a critic network and a discriminator network for the discriminator for the agent.

6. The generative adversarial imitation learning device of claim 5, wherein the global encoder processor shares the global encoder through a global encoding unit of the agent and a global encoding unit of the discriminator.

7. The generative adversarial imitation learning device of claim 6, wherein the global encoder processor performs the training such that the state is converted into a feature vector through each of the global encoding unit of the agent and the global encoding unit of the discriminator to process the action.

8. The generative adversarial imitation learning device of claim 5, wherein the global encoder processor improves the training such that a cost function for evaluating imitation of the expert by the agent is minimized.

9. The generative adversarial imitation learning device of claim 1, wherein the agent learning unit optimizes a policy in the path of the expert through the GAIL to perform learning such that actions of the agent are similar to actions of the expert.

10. A generative adversarial imitation learning method performed in a generative adversarial imitation learning device, comprising:
a learning initialization step of receiving path data of an expert composed of a sequence of actions performed in the past and initializing parameters of a global encoder shared by an agent and a discriminator;
a sample extraction step of extracting samples from a path of the expert;
a global encoder processing step of training the agent and the discriminator through the samples to update the parameters of the global encoder and fix the parameters of the global encoder when the training is completed; and
an agent learning step of performing GAIL to imitate actions of the expert by the agent.
